(19) United States
(12) Patent Application Publication
(10) Pub. No.: US 2026/0145408 A1
(43) Pub. Date: May 28, 2026

(54) HIGH TEMPERATURE RESISTANT INSULATING FILM

(71) Applicant: Illinois Tool Works Inc., Glenview, IL (US)

(72) Inventor: Run SU, Shanghai (CN)

(21) Appl. No.: 19/119,141

(22) PCT Filed: Oct. 4, 2023
(86) PCT No.: PCT/US2023/075974

§ 371 Date: Apr. 8, 2025

(30) Foreign Application Priority Data
Oct. 11, 2022 (CN) 202211241696.8
Oct. 11, 2022 (CN) 202222677854.6
Aug. 25, 2023 (CN) 202311080805.7

(51) Int. Cl. B32B 19/04; B32B 7/12; B32B 37/06; B32B 37/10; B32B 37/12; B32B 37/24; B32B 38/00; H01M 10/658

(52) U.S. Cl. CPC B32B 19/045; B32B 7/12; B32B 37/06; B32B 37/10; B32B 37/1284; B32B 37/24; B32B 38/0036; B32B 2037/243; B32B 2038/0076; B32B 2250/03; B32B 2250/40; B32B 2255/02; B32B 2255/26; B32B 2307/304; B32B 2307/306; B32B 2307/7376; B32B 2309/02; B32B 2309/12; B32B 2309/14; B32B 2310/0831; H01M 10/658

(57) ABSTRACT

The present application discloses a method for producing a high-temperature-resistant insulating film, which comprises the following steps: applying an uncured material to the upper surface and the lower surface of a mica layer to cure the uncured material. The high-temperature-resistant insulating film produced by the method disclosed in the present application not only possesses excellent high-temperature resistance, superior mechanical performance, and exceptional insulation performance but also features a simple production process, resulting in significantly lower costs compared to conventional plastic films.

### RELATED APPLICATIONS

This international application claims priority to Chinese Patent Application No. 202211241696.8, filed Oct. 11, 2022, to Chinese Patent Application No. 202222677854.6, filed Oct. 11, 2022, and to Chinese Patent Application No. 202311080805.7, filed Aug. 25, 2023. The entireties of Chinese Patent Application No. 202211241696.8, Chinese Patent Application No. 202222677854.6, and Chinese Patent Application No. 202311080805.7 are incorporated herein by reference.

### TECHNICAL FIELD

The present application relates to the field of films, in particular to a high-temperature-resistant insulating film.

### BACKGROUND

Insulation films are used to isolate various electronic devices or components to prevent failures caused by short circuits, breakdowns, etc., between or within electronic devices or components. Some insulating films also need to have high-temperature resistance to reduce the impact of localized high temperatures on electronic devices or components, ensuring the normal operation of various electronic devices or components.

### SUMMARY

The object of the present application is to provide a high-temperature-resistant insulating film for use in electronic devices or components, which meets the insulating requirements of electronic devices or components while also possessing excellent high-temperature resistance. Additionally, this high-temperature-resistant insulating film possesses excellent mechanical performance to meet the requirements of the usage environment.

The present application provides, in a first aspect, a method for producing a high-temperature-resistant insulating film, which comprises the following steps: applying an uncured material to the upper surface and the lower surface of the mica layer for high-temperature-resistant insulation; and curing the uncured material to obtain an upper additional layer of high-temperature-resistant insulation attached to the upper surface of the mica layer for high-temperature-resistant insulation and a lower additional layer of high-temperature-resistant insulation attached to the lower surface of the mica layer for high-temperature-resistant insulation; the outer surface of the upper additional layer of high-temperature-resistant insulation forms the first outer surface of the high-temperature-resistant insulating film for high-temperature-resistant insulation, and the outer surface of the lower additional layer of high-temperature-resistant insulation forms the second outer surface of the high-temperature-resistant insulating film for high-temperature-resistant insulation.

According to the aforementioned first aspect, the step of applying the uncured material to the upper surface and the lower surface of the mica layer for high-temperature-resistant insulation is carried out through processes such as roll coating, blade coating, or spray coating.

According to the aforementioned first aspect, the step of curing the uncured material is initiated through radiation.

According to the aforementioned first aspect, the radiation involves exposure to ultraviolet light, with a wavelength of 300-370 nm, and a radiation intensity of 60-120 w/cm².

According to the aforementioned first aspect, the coating thickness of the uncured material is 0.02-0.05 mm.

According to the aforementioned first aspect, the uncured material is epoxy resin coating, and the step of curing the uncured material is by heating the uncured material to 60-120° C.

According to the aforementioned first aspect, the coating thickness of the uncured epoxy resin coating is 0.02-0.1 mm.

According to the aforementioned first aspect, the uncured material is PU coating, and the step of curing the uncured material is by drying.

According to the aforementioned first aspect, the thickness of the mica layer for high-temperature-resistant insulation is 0.1-3 mm, and the thickness of the cured upper additional layer of high-temperature-resistant insulation and the lower additional layer of high-temperature-resistant insulation is within 100 μm.

The present application provides, in a second aspect, a method for producing a high-temperature-resistant insulating film, which comprises the following steps: applying adhesive to the upper surface and the lower surface of the mica layer for high-temperature-resistant insulation to obtain the upper bonding layer of high-temperature-resistant insulation and the lower bonding layer of high-temperature-resistant insulation, respectively; bonding the upper additional layer of high-temperature-resistant insulation to the upper surface of the mica layer for high-temperature-resistant insulation through the upper bonding layer of high-temperature-resistant insulation, and bonding the lower additional layer of high-temperature-resistant insulation to the lower surface of the mica layer for high-temperature-resistant insulation through the lower bonding layer of high-temperature-resistant insulation, such that the outer surface of the upper additional layer of high-temperature-resistant insulation forms the first outer surface of the high-temperature-resistant insulating film for high-temperature-resistant insulation, and the outer surface of the lower additional layer of high-temperature-resistant insulation forms the second outer surface of the high-temperature-resistant insulating film for high-temperature-resistant insulation.

According to the aforementioned second aspect, the step of bonding the upper additional layer of high-temperature-resistant insulation to the upper surface of the mica layer for high-temperature-resistant insulation through the upper bonding layer of high-temperature-resistant insulation, and bonding the lower additional layer of high-temperature-resistant insulation to the lower surface of the mica layer for high-temperature-resistant insulation through the lower bonding layer of high-temperature-resistant insulation, comprises the following: applying a plastic film to each of the upper bonding layer of high-temperature-resistant insulation and the lower bonding layer of high-temperature-resistant insulation, and bonding the plastic films to the upper surface and the lower surface of the mica layer for high-temperature-resistant insulation, respectively through a lamination process, thereby obtaining the upper additional layer of high-temperature-resistant insulation and the lower additional layer of high-temperature-resistant insulation.

According to the aforementioned second aspect, the temperature and pressure of the lamination process are 95-125° C. and 3-25 MPa, respectively.

According to the aforementioned second aspect, the speed of application of the upper additional layer of high-temperature-resistant insulation and the lower additional layer of high-temperature-resistant insulation is 2-20 m/min.

According to the aforementioned second aspect, the coating thickness of the upper bonding layer of high-temperature-resistant insulation and the lower bonding layer of high-temperature-resistant insulation is 0.01-0.05 mm.

According to the aforementioned second aspect, the lamination process ensures that the total thickness of the upper additional layer of high-temperature-resistant insulation and the upper bonding layer of high-temperature-resistant insulation, as well as the total thickness of the lower additional layer of high-temperature-resistant insulation and the lower bonding layer of high-temperature-resistant insulation, are both within 100 μm.

### BRIEF DESCRIPTION OF THE DRAWINGS

FIG. 1A is a schematic view of the three-dimensional structure of an example of the high-temperature-resistant insulating film according to the present application;

FIG. 1B is a sectional view along line A-A of the high-temperature-resistant insulating film as shown in FIG. 1A;

FIG. 1C is a schematic view of the three-dimensional structure of another example of the high-temperature-resistant insulating film according to the present application;

FIG. 1D is a sectional view along line B-B of the high-temperature-resistant insulating film as shown in FIG. 1C;

FIG. 2A is a flow chart illustrating the production process of the high-temperature-resistant insulating film as shown in FIG. 1A;

FIG. 2B is a flow chart illustrating the production process of the high-temperature-resistant insulating film as shown in FIG. 1A;

FIG. 2C is a schematic view of a spray coating equipment;

FIG. 2D is a schematic view of a laminating equipment;

FIG. 3A is a schematic view of the three-dimensional structure of a battery module comprising the high-temperature-resistant insulating film as shown in FIG. 1A;

FIG. 3B is an exploded view of the battery module as shown in FIG. 3A.

### DETAILED DESCRIPTION

Various specific embodiments of the present application will be described below with reference to the accompanying drawings that form a part of the present specification. It should be understood that while terms denoting orientation, such as “front,” “rear,” “upper,” “lower,” “left,” “right,” “top,” “bottom,” “inside,” “outside,” etc., are used in the present application to describe various exemplary structural parts and elements of the present application, these terms are used herein for convenience of illustration only and are determined based on the exemplary orientations shown in the accompanying drawings. Since the examples disclosed in the present application may be disposed in different orientations, these terms denoting orientation are for illustrative purposes only and should not be considered as limiting.

In the present application, unless otherwise specified, all equipment and materials may be purchased from the market or are commonly used in the industry. The methods in the following examples, unless specifically stated, are conventional methods in this field.

The mica layer in the present application is formed by bonding mica paper or mica powder with an adhesive and then subjecting it to heat pressing; wherein, mica accounts for approximately 90% of the weight, and the adhesive accounts for approximately 10% of the weight. As an example, the adhesive is organic silicone glue. The mica paper or mica powder may be golden mica, white mica, or other synthetic mica. In certain examples, the mica layer is a commercially available mica sheet or mica board.

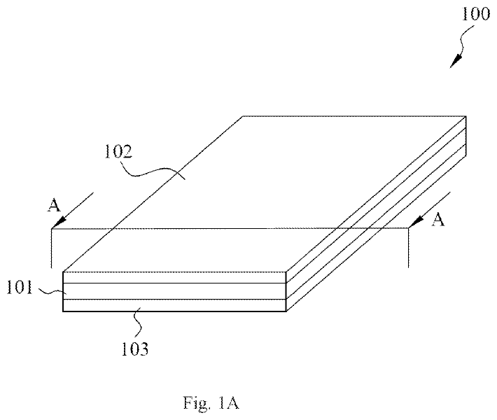

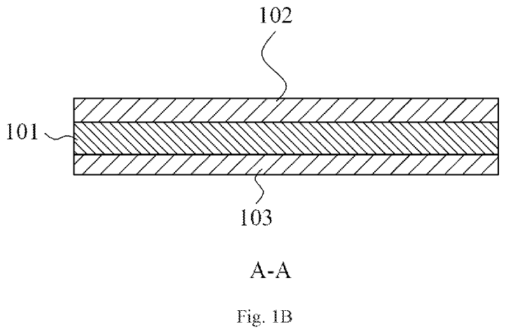

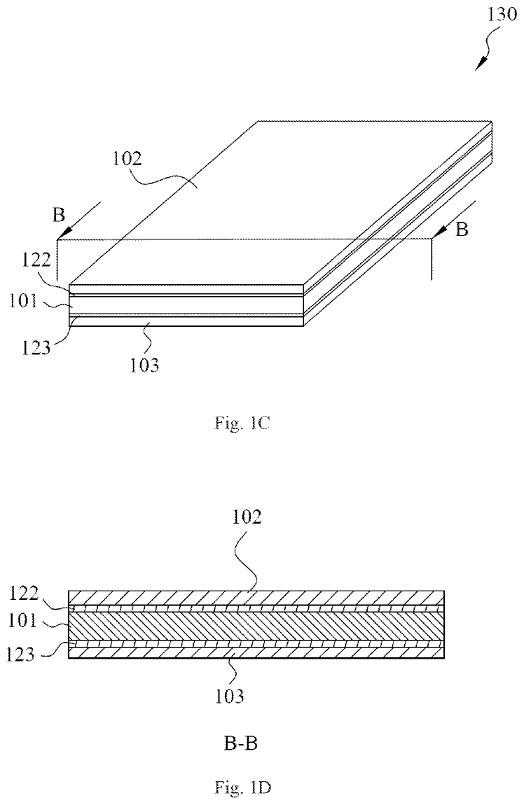

FIGS. 1A and 1B illustrate the specific structure of a high-temperature-resistant insulating film 100 according to an example of the present application. As shown in FIGS. 1A and 1B, the high-temperature-resistant insulating film 100 comprises a mica layer 101, an upper additional layer 102, and a lower additional layer 103. As an example, the thickness of the mica layer 101 is 0.1-3 mm, and the thickness of the upper additional layer 102 and the lower additional layer 103 is within 100 μm.

The inner surface of the upper additional layer 102 is attached to the upper surface of the mica layer 101, and the outer surface of the upper additional layer 102 forms the first outer surface of the high-temperature-resistant insulating film 100 (i.e., the upper outer surface). In the example shown in FIGS. 1A and 1B, the inner surface of the upper additional layer 102 is directly attached to the upper surface of the mica layer 101. The inner surface of the lower additional layer 103 is attached to the lower surface of the mica layer 101, and the outer surface of the lower additional layer 103 forms the second outer surface of the high-temperature-resistant insulating film 100 (i.e., the lower outer surface). In the present example, the inner surface of the lower additional layer 103 is directly attached to the lower surface of the mica layer 101.

The upper additional layer 102 and the lower additional layer 103 are made of materials different from the mica layer 101. The upper additional layer 102 and the lower additional layer 103 may be made of the same material or different materials. In the present example, the upper additional layer 102 and the lower additional layer 103 are made of the same material. The material of the upper additional layer 102 and the lower additional layer 103 has an uncured state and a cured state. When the material of the upper additional layer 102 and the lower additional layer 103 is in an uncured state, they are applied and bonded to the upper surface and the lower surface of the mica layer 101, respectively. When the material of the upper additional layer 102 and the lower additional layer 103 is in a cured state, they form the upper reinforcement layer and the lower reinforcing layer, respectively. The upper reinforcement layer and the lower reinforcement layer refer to additional layers that enhance the mechanical performance of the mica layer.

The cured state of the upper additional layer 102 and the lower additional layer 103 is a chemically crosslinked cured coating. During the production process, the uncured material is first applied to the upper surface and the lower surface of the mica layer 101 through processes such as roll coating, blade coating, or spray coating; next, the uncured material is converted to the cured state to obtain the cured upper additional layer 102 and the lower additional layer 103. In some examples, the conversion of the upper additional layer 102 and the lower additional layer 103 from an uncured state to a cured state is initiated through radiation. In a specific example, the uncured material that may be cured by radiation is a commercially available UV light-curable adhesive coating with a coating thickness of 0.02-0.05 mm, and this coating may be transformed into a cured state by exposure to ultraviolet light with a wavelength of 300-370 nm and a radiation intensity of 60-120 w/cm². In some other examples, the conversion of the upper additional layer 102 and the lower additional layer 103 from an uncured state to a cured state is achieved through heating or drying. In a specific example, the uncured material that may be cured through heating or drying is an epoxy resin coating with a coating thickness of 0.02-0.1 mm, and this coating may be converted to a cured state through heating to 60-120° C. In another specific example, the uncured material that may be cured through heating or drying is a PU (polyurethane) coating, and this coating may be converted to a cured state by air-drying.

FIG. 1C and ID illustrate the specific structure of a high-temperature-resistant insulating film 130 according to another example of the present application. As shown in FIGS. 1C and 1D, the high-temperature-resistant insulating film 130 comprises a mica layer 101, an upper additional layer 102, and an upper bonding layer 122, as well as a lower additional layer 103 and a lower bonding layer 123. As an example, the thickness of the mica layer 101 is 0.1-3 mm, the total thickness of the upper additional layer 102 and upper bonding layer 122 is within 100 μm, and the total thickness of the lower additional layer 103 and lower bonding layer 123 is also within 100 μm. In the present example, the upper additional layer 102 and the lower additional layer 103 do not have adhesive properties; in other words, they cannot directly adhere to the upper surface and the lower surface of the mica layer 101 on their own. Meanwhile, the upper bonding layer 122 and lower bonding layer 123 do not provide reinforcement; in other words, they cannot enhance the mechanical performance of the mica layer 101.

In the example shown in FIGS. 1C and 1D, the inner surface of the upper additional layer 102 is attached to the upper surface of the mica layer 101 through the upper bonding layer 122, and the outer surface of the upper additional layer 102 forms the first outer surface of the high-temperature-resistant insulating film 130 (i.e., upper outer surface). The inner surface of the lower additional layer 103 is attached to the lower surface of the mica layer 101 through the lower bonding layer 123, and the outer surface of the lower additional layer 103 forms the second outer surface of the high-temperature-resistant insulating film 130 (i.e., lower outer surface).

The upper additional layer 102 and the lower additional layer 103 are made of materials different from the mica layer 101. The upper additional layer 102 and the lower additional layer 103 may be made of the same material or different materials. In the present example, the upper additional layer 102 and the lower additional layer 103 are made of the same material. In some examples, the upper additional layer 102 and the lower additional layer 103 are plastic films, such as PET (polyethylene terephthalate) film or PP (polypropylene) film. The upper bonding layer 122 and the lower bonding layer 123 are adhesives, such as hot-melt adhesive or thermosetting adhesive. The adhesive in the present example is hot-melt adhesive. The upper additional layer 102 and the lower additional layer 103 form the upper reinforcement layer and the lower reinforcement layer, respectively, enhancing the mechanical performance of the mica layer 101. The upper bonding layer 122 and the lower bonding layer 123 do not serve as reinforcement layers.

In the production process, specifically, hot-melt adhesive is first applied to the upper surface and the lower surface of the mica layer 101 through processes such as roll coating, blade coating, or spray coating to obtain the upper bonding layer 122 and the lower bonding layer 123, respectively; next, a plastic film is applied to each of the upper bonding layer 122 and the lower bonding layer 123; and finally, the plastic films are attached to the upper surface and the lower surface of the mica layer 101, respectively through the lamination process, forming the upper additional layer 102 and the upper bonding layer 122, as well as the lower additional layer 103 and the lower bonding layer 123. In some examples, the coating thickness of the upper bonding layer 122 and lower bonding layer 123 is 0.01-0.05 mm.

Those skilled in the art would understand that the materials for the upper additional layer 102 and lower additional layer 103 are not limited to the aforementioned examples.

The various examples of the high-temperature-resistant insulating film in the present application possess excellent high-temperature resistance, with the ability to withstand temperatures of 600-700° C. or higher. Furthermore, the high-temperature-resistant insulating film exhibits exceptional high-temperature-resistant insulation properties, maintaining its insulation even at temperatures of 600-700° C. The high-temperature-resistant insulating film also possesses superior mechanical performance, with a tensile strength of over 100 MPa. Compared to conventional plastic-based insulating films, the high-temperature-resistant insulating film described in the present application not only offers superior heat resistance at elevated temperatures but is also cost-effective.

The applicant has observed that commercially available mica sheets or boards, due to the need for adhesive bonding and pressing during their production process, are prone to fragmentation and detachment during transportation or assembly with other components. In the application environment of certain electronic products, the fragments that fall off may adversely affect the performance stability of the electronic products and are detrimental to the environment.

In contrast, the surface of the high-temperature-resistant insulating film in the present application is no longer the mica layer but the outer surface of each additional layer, which effectively prevents the mica layer from generating fragments, and even if fragments generated, they are unlikely to fall off, thereby averting adverse impact on the performance stability of electronic products.

Furthermore, the applicant has also found that although the thickness of the upper additional layer and the lower additional layer is relatively thin compared to the mica layer, they are capable of significantly improving the mechanical performance of the mica layer. For example, the high-temperature-resistant insulating film of the present application, compared to existing mica sheets or boards, has better flexural resistance and fracture resistance. Even when the high-temperature-resistant insulating film is subjected to bending stress, it is less prone to fracturing. As a specific example, existing mica boards, after bending twice at a 60° angle, fracture and generate fragments that fall off. In contrast, the high-temperature-resistant insulating film described in the present application is capable of being repeatedly bent 7-9 times without fracturing or generating fragments that fall off.

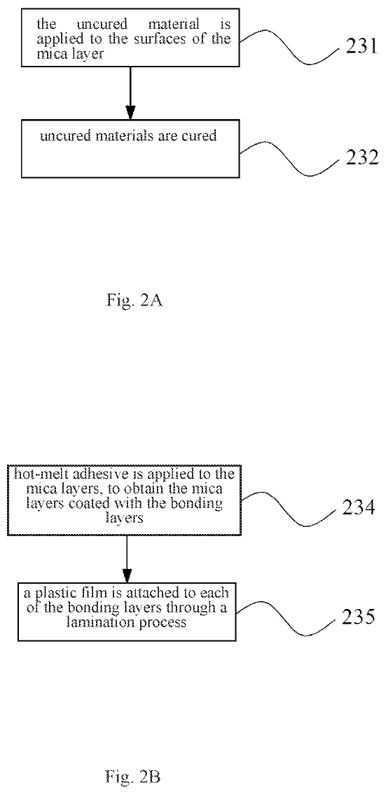

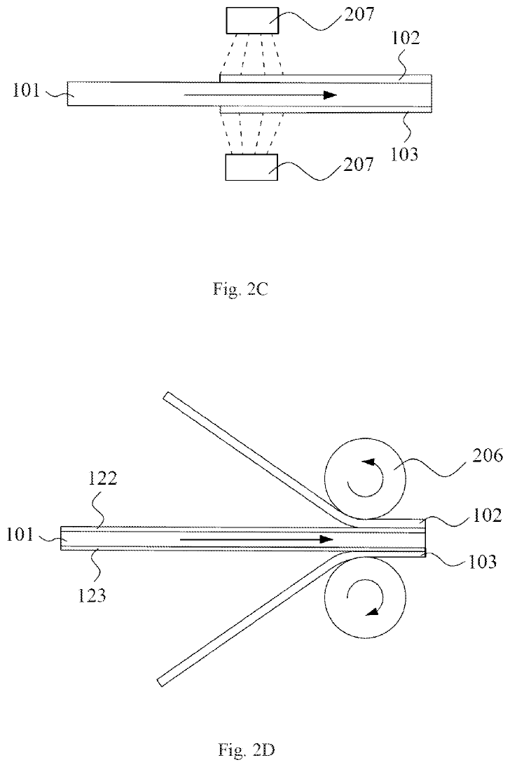

A specific description of the production method for the high-temperature-resistant insulating films 100 and 130 is provided below in conjunction with FIGS. 2A to 2D. FIG. 2A illustrates the process of the production method for the high-temperature-resistant insulating film 100. FIG. 2B illustrates the process of the production method for the high-temperature-resistant insulating film 130. FIG. 2C is a schematic view of the spray coating equipment for applying the uncured material to the upper surface and the lower surface of the mica layer 101. FIG. 2D is a schematic diagram view of the laminating equipment for pressing the plastic film onto the bonding layers 122 and 123 of the high-temperature-resistant insulating film 130.

As shown in FIGS. 2A and 2C, in step 231, the uncured material is applied to the upper surface and the lower surface of the mica layer 101 through a spray coating process. Specifically, during the production process, a pair of nozzles 207 of the spray coating equipment are fixed above and below the mica layer 101, respectively. The mica layer 101 is conveyed from left to right between the pair of nozzles 207, to apply the uncured upper additional layer 102 and lower additional layer 103 on the upper surface and the lower surface of the mica layer 101, respectively. After the spraying is completed, step 232 is initiated. In step 232, the uncured upper additional layer 102 and lower additional layer 103 are cured through methods such as radiation, heating, or drying, to obtain the high-temperature-resistant insulating film 100.

As shown in FIGS. 2B and 2D, in step 234, hot-melt adhesive is applied on the upper surface and the lower surface of the mica layer 101, to obtain the mica layer 101 coated with the upper bonding layer 122 and the lower bonding layer 123. Then, in step 235, a plastic film is attached to each of the upper bonding layer 122 and the lower bonding layer 123 through a lamination process. Specifically, during the production process, the mica layer 101 coated with the upper bonding layer 122 and the lower bonding layer 123 is conveyed from left to right between a pair of rollers 206; simultaneously, the plastic films are also conveyed through the pair of rollers 206, applying the plastic films from above the upper bonding layer 122 and below the lower bonding layer 123, respectively. The speed of application of the plastic film is 2-20 m/min. The pair of rollers 206 rotates in opposite directions, and by heating and pressing, the plastic films are connected to the corresponding bonding layers, thereby attaching the plastic films to the upper and lower surfaces of the mica layer 101, respectively. In the present example, the roller 206 above the mica layer 101 rotates counterclockwise, and the roller 206 below the mica layer 101 rotates clockwise to press the plastic films onto the upper bonding layer 122 and lower bonding layer 123, respectively. The pressure applied by the two rollers 206 on the mica layer 101 and plastic films passing between them is 3-25 MPa, and the temperature (i.e., laminating temperature) at which the mica layer 101 and plastic films pass between the two rollers 206 is controlled in the range of 95-125° C.

The high-temperature-resistant insulating film described in the present application may be utilized in various electronic products or equipment to aid in heat dissipation. Such electronic products or equipment may include electrical equipment such as battery modules, heating coils, or electric motors.

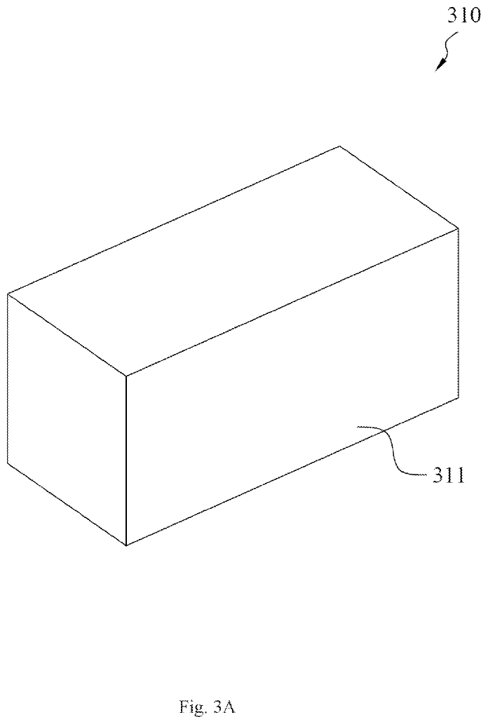

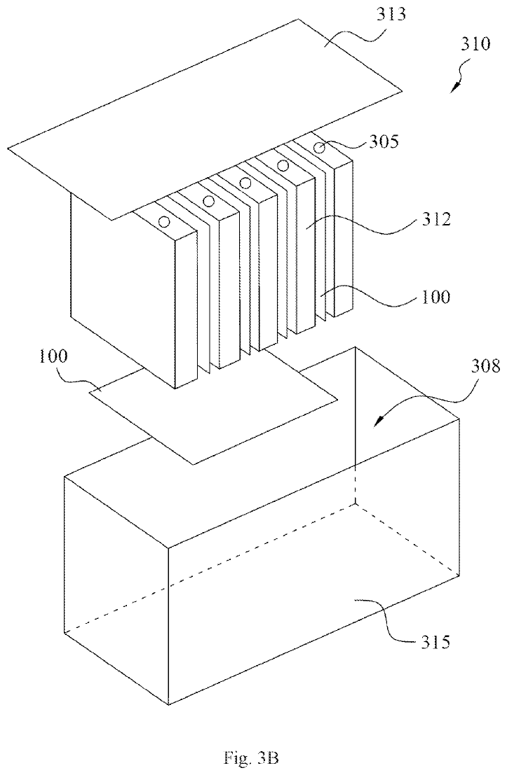

FIGS. 3A and 3B are schematic diagrams illustrating the structure of an example of a battery module comprising the high-temperature-resistant insulating film 100 of the present application, wherein FIG. 3A illustrates the overall structure of the battery module 310, while FIG. 3B illustrates the disassembled structure of the battery module 310. As shown in FIGS. 3A and 3B, battery module 310 comprises several battery units 312 and a housing 311. The housing 311 comprises a substantially square box-like body 315 and an upper lid 313, wherein the box 315 has an accommodating cavity 308, and the upper lid 313 is disposed on top of the box-like body 315 to enclose the accommodating cavity 308. A plurality of battery units 312 are housed within the accommodating cavity 308 of the box-like body 315. Each battery unit 312 has its own connecting terminal 305. After the respective connecting terminals 305 of these battery units 312 are electrically connected according to a predetermined circuit, power and/or charging is provided externally through the main connecting terminal (not shown in the figure) disposed on the housing 311.

The high-temperature-resistant insulating film 100 is positioned between adjacent battery units 312, and is also positioned between each battery unit 312 and the box-like body 105. In some examples, the high-temperature-resistant insulating film 100 is secured between adjacent battery units 312 or between each battery unit 312 and the box-like body 105 using fasteners such as bolts. In some examples, the high-temperature-resistant insulating film 100 is bonded between adjacent battery units 312 or between each battery unit 312 and the box-like body 105 using adhesive. In addition to insulating between adjacent battery units 312, the high-temperature-resistant insulating film 100 also prevents some battery units 312 from generating excessive heat and reaching high temperatures, which could lead to damage to the battery module 310 as a whole.

Furthermore, during the transportation of the battery module 310, the high-temperature-resistant insulating film 100 also provides a certain degree of support, preventing deformation due to mutual compression between the battery units 312.

If a high-temperature-resistant plastic film were used between the battery units 312, it would not only incur higher costs but also provide limited support. Moreover, even high-temperature-resistant plastic films have limited heat resistance. If the temperature of the battery unit 312 becomes too high, the plastic film may still melt or become damaged. Meanwhile, if conventional mica sheets available in the market are used between the battery units 312, although the heat resistance is improved, fragments of mica sheets are likely to fall off during transportation and installation. These fragments may fall into the box-like body 315, potentially affecting the performance of the battery module 310.

In contrast, the high-temperature-resistant insulating film described in the present application uses mica sheet as an intermediate layer, with additional layers disposed above and below the mica layer. This enhances the mechanical performance of the mica layer while retaining its high-temperature resistance. It also prevents fragments of the mica layer from falling off, making transportation and installation of the high-temperature-resistant insulating film more convenient. Moreover, this design is particularly suitable for heat dissipation and support within battery units.

Finally, the high-temperature-resistant insulating film described in the present application has numerous beneficial technical effects. Below are at least some of the technical effects of the high-temperature-resistant insulating film disclosed in the present application:
1. excellent high-temperature resistance, with the ability to withstand temperatures of 600-700° C. or higher, meeting the heat resistance requirements of electronic products and equipment.
2. superior mechanical performance with a tensile strength of over 100 MPa, and the ability to be bent repeatedly without damage, ensuring durability during transportation, packaging, and processing by manufacturers of electronic products and equipment.
3. exceptional insulation performance, especially at high temperatures, meeting the insulation requirements of electronic products and equipment.
4. simple production process.
5. convenient to use and cost-effective, with significantly lower costs compared to typical plastic films.

Although the present disclosure has been described in connection with the exemplary examples outlined above, various alternatives, modifications, variations, improvements, and/or substantial equivalents, whether known or foreseeable now or in the near future, may be apparent to those having at least ordinary skill in the art. Therefore, the exemplary examples of the present disclosure set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents. The technical effects and technical problems in this specification are exemplary and not limiting. It should be noted that the examples described in this specification may have other technical effects and may solve other technical problems.

1. A method for producing a high-temperature-resistant insulating film, comprising:
applying an uncured material to the upper surface and the lower surface of a mica layer;
curing the uncured material to obtain an upper additional layer attached to the upper surface of the mica layer and an lower additional layer attached to the lower surface of the mica layer; the outer surface of the upper additional layer forms the first outer surface of the high-temperature-resistant insulating film, and the outer surface of the lower additional layer forms the second outer surface of the high-temperature-resistant insulating film.

2. The method for producing a high-temperature-resistant insulating film according to claim 1, wherein the applying the uncured material to the upper surface and the lower surface of the mica layer is carried out through at least one of roll coating, blade coating, or spray coating.

3. The method for producing a high-temperature-resistant insulating film according to claim 1, wherein curing the uncured material is initiated through radiation.

4. The method for producing a high-temperature-resistant insulating film according to claim 3, wherein the radiation involves exposure to ultraviolet light, with a wavelength of 300-370 nm, and a radiation intensity of 60-120 w/cm².

5. The method for producing a high-temperature-resistant insulating film according to claim 3, wherein the coating thickness of the uncured material is 0.02-0.05 mm.

6. The method for producing a high-temperature-resistant insulating film according to claim 1, wherein the uncured material is epoxy resin coating, and the curing of the uncured material comprises heating the uncured material to 60-120° C.

7. The method for producing a high-temperature-resistant insulating film according to claim 6, wherein the coating thickness of the uncured epoxy resin coating is 0.02-0.1 mm.

8. The method for producing a high-temperature-resistant insulating film according to claim 1, wherein the uncured material is PU coating, and the curing of the uncured material comprises drying.

9. The method for producing a high-temperature-resistant insulating film according to claim 1, wherein the thickness of the mica layer is 0.1-3 mm, and the thickness of the cured upper additional layer and lower additional layer is within 100 μm.

10. The method for producing a high-temperature-resistant insulating film, comprising:
applying adhesive to the upper surface and the lower surface of a mica layer to obtain an upper bonding layer and a lower bonding layer, respectively;
bonding an upper additional layer to the upper surface of the mica layer through the upper bonding layer, and bonding a lower additional layer to the lower surface of the mica layer through the lower bonding layer, such that the outer surface of the upper additional layer forms the first outer surface of the high-temperature-resistant insulating film, and the outer surface of the lower additional layer forms the second outer surface of the high-temperature-resistant insulating film.

11. The method for producing a high-temperature-resistant insulating film according to claim 10, wherein the bonding of the upper additional layer to the upper surface of the mica layer through the upper bonding layer and bonding the lower additional layer to the lower surface of the mica layer through the lower bonding layer comprises:
applying a plastic film to each of the upper bonding layer and the lower bonding layer; and
bonding the plastic films to the upper surface and the lower surface of the mica layer, respectively through a lamination process, thereby obtaining the upper additional layer and the lower additional layer.

12. The method for producing a high-temperature-resistant insulating film according to claim 11, wherein the temperature and pressure of the lamination process are 95-125° C. and 3-25 MPa, respectively.

13. The method for producing a high-temperature-resistant insulating film according to claim 11, wherein the speed of application of the upper additional layer and the lower additional layer is 2-20 m/min.

14. The method for producing a high-temperature-resistant insulating film according to claim 10, wherein the coating thickness of the upper bonding layer and the lower bonding layer is 0.01-0.05 mm.

15. The method for producing a high-temperature-resistant insulating film according to claim 14, wherein the lamination process ensures that the total thickness of the upper additional layer and the upper bonding layer, as well as the total thickness of the lower additional layer and the lower bonding layer are both within 100 μm.
